(19) United States
(12) Patent Application Publication
(10) Pub. No.: US 2026/0099461 A1
(43) Pub. Date: Apr. 9, 2026

(54) DYNAMIC CPUSET ALLOCATION TO WORKLOADS FOR IMPROVED ENERGY EFFICIENCY

(71) Applicant: Rakuten Symphony, Inc., Tokyo (JP)

(72) Inventors: Sree Nandan Atur, San Mateo, CA (US); Mruthyunjaya Navali, Boston, MA (US); Ayushi Nikhil Patani, Pune (IN); Nikhil Rohidas Gawade, Pune (IN); Shravan Vallala, San Mateo, CA (US); Manjunath Mageswaran, San Mateo, CA (US); Tushar Doshi, San Mateo, CA (US)

(21) Appl. No.: 18/909,533

(22) Filed: Oct. 8, 2024

(51) Int. Cl. G06F 15/78

(52) U.S. Cl. CPC G06F 15/7882

(57) ABSTRACT

A system includes plurality of processor cores and a memory device storing executable code that, when executed by the plurality of processor cores, causes the plurality of processor cores to: receive a specification for including a request for a first number of processor cores and a limit of a second number of processor cores that is greater than the first number; reserve a full set of processor cores including the second number of processor cores for use by an instance of the software module; instantiate an instance of a software module; and configure the instance to use a reduced set of processors cores, the reduced set of processor cores including a third number of processor cores that is greater than the first number and less than the second number.

### BACKGROUND

### Field of the Invention

The present disclosure relates to Dynamic CPUset allocation to workloads for improved energy efficiency.

### Background of the Invention

The information disclosed in this background section is only for enhancement of understanding of the general background of the disclosure and should not be taken as an acknowledgement or any form of suggestion that this information forms the prior art already known to a person skilled in the art.

Enterprises with a large number of computing devices, such as data centers or telecommunication networks, must manage the amount of power consumed. A typical enterprise may allocate resources to accommodate occasional high loads that are otherwise unused. In some instances, such resources may consume power even when not needed..

### SUMMARY OF THE INVENTION

In one aspect, a system includes plurality of processor cores and a memory device operably coupled to the plurality of processor cores. The memory device stores executable code that, when executed by the plurality of processor cores, causes the plurality of processor cores to: receive a specification for a software module, the specification including a request for a first number of processor cores of the plurality of processor cores and a limit of a second number of processor cores of the plurality of processor cores that is greater than the first number; reserve a full set of processor cores including the second number of processor cores of the plurality of processor cores for use by an instance of the software module; instantiate the instance of the software module; and configure the instance to use a reduced set of processors cores of the plurality of processors cores, the reduced set of processor cores including a third number of processor cores of the plurality of processor cores, the third number being greater than the first number and less than the second number.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a network environment in which containers may be deployed in accordance with an embodiment;

FIG. 2 is a schematic block diagram showing components for allocating CPUs in accordance with an embodiment;

FIG. 3 is a schematic block diagram of components for implementing elastic burstable pods in accordance with an embodiment;

FIG. 4 is a process flow diagram of a method for implementing elastic burstable pods in accordance with an embodiment; and

FIG. 5 is a schematic block diagram of an example computing device suitable for implementing methods in accordance with embodiments of the disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more. ” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

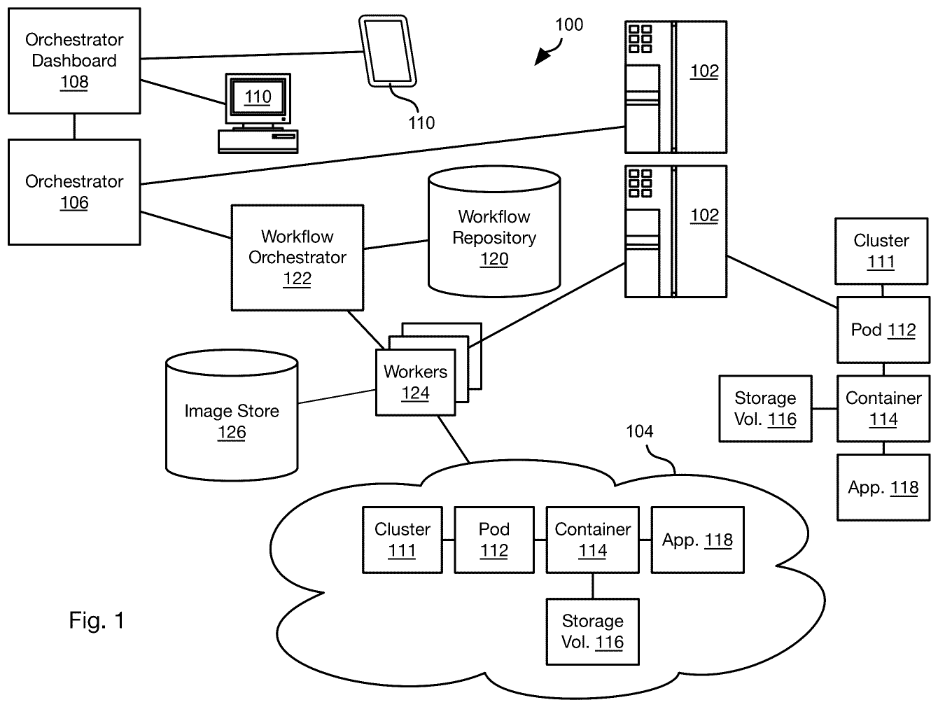

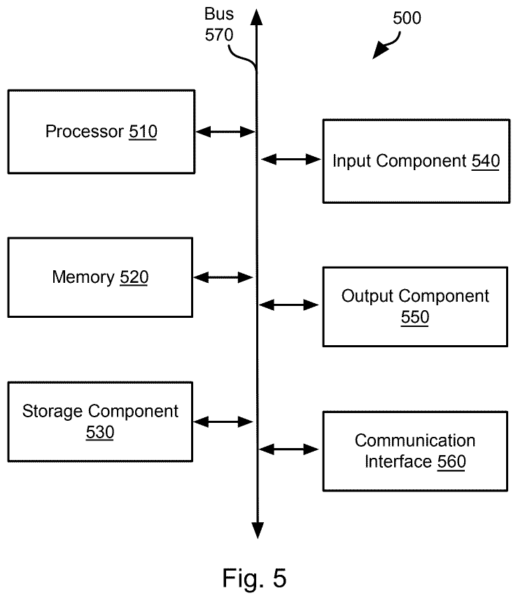

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102. Each of the servers 102 may include one or more computing devices, such as a computing device having some or all of the attributes of the computing device 500 of FIG. 5.

Computing resources may also be allocated and utilized within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform.

In some embodiments, some or all of the servers 102 may function as edge servers in a telecommunication network. Servers 102 that function as edge servers may have limited computational resources or may be heavily loaded.

An orchestrator 106 provisions computing resources to application instances 118 of one or more different application executables, such as according to a manifest that defines requirements of computing resources for each application instance. The manifest may define dynamic requirements defining the scaling up or scaling down of a number of application instances 118 and corresponding computing resources in response to usage. The orchestrator 106 may include or cooperate with a utility such as KUBERNETES to perform dynamic scaling up and scaling down the number of application instances 118.

An orchestrator 106 may execute on a computer system that is distinct from the servers 102 and is connected to the servers 102 by a network that requires the use of a destination address for communication, such as using a networking including ethernet protocol, internet protocol (IP), Fiber Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QoS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

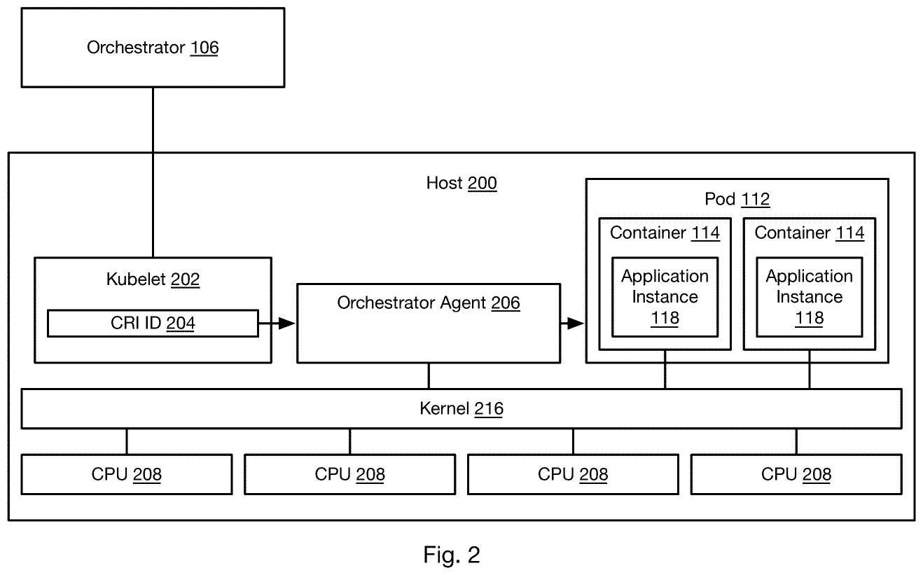

Referring to FIG. 2, a host 200 may be a server 102, a unit of computing resources on the cloud computing platform 104, a virtual machine, or other computing device. A Kubelet 202 may execute on the host 200. The Kubelet 202 may implement a pod 112 on the host 200 and manage containers 114 and corresponding application instances 118 executing on the host 200. The Kubelet 202, and the pod 112 implemented by the Kubelet 202, may function as a logical host for multiple containers 114. The pod 112 may include a set of namespaces, a file system (e.g., built on a storage volume 116), or other data structures that are shared by containers 114 belonging to the pod 112.

The Kubelet 202 may be configured with a container runtime interface (CRI) identifier 204 that refers to an orchestrator agent 206 that is an agent of the orchestrator 106 and may communicate with the orchestrator 106 in order to perform the functions ascribed herein to the orchestrator agent 206. The Kubelet 202 may call the orchestrator agent 206 as a CRI to perform tasks with respect to containers 114 instantiated in the pod 112, such as to instantiate containers 114, suspend containers 114, de-instantiate containers 114, monitor the status of containers 114, monitor usage of computing resources by the containers 114, and other tasks. The orchestrator 106 performs tasks as instructed by the Kubelet 202 and performs additional functions in order to extend the functionality of the pod 112 and containers 114 beyond that provided by conventional KUBERNETES.

In particular, the orchestrator agent 206 may be used to modify behavior of conventional KUBERNETES with respect to burstable pods. A burstable pod 112 is one that utilizes a base number of CPUs 208, e.g., processor cores of one or more processor chips, but additionally reserves an additional number of CPUs 208 for occasional use. The orchestrator agent 206 may interface with a kernel 216 executing on the host 200 in order to manage the execution of pods 112 and containers 114 by the CPUs 208.

Each CPU 208 may operate in a plurality of power states, referred to herein as “cstates.” Each cstate has a different power consumption. Each make and model of processor may have different cstates. As used herein, C₀ refers an active mode in which executable code is being executed and CPU 208 is operating at maximum clock speed and in which the CPU 208 consumes the most power as compared to other cstates. In the remaining cstates (C₁ to C_{N}), the amount of time required to return to the C₀ cstate increases with increasing index value (e.g., Cₙ takes longer to return to C₀ than Cₙ₋₁, etc., where n is a value from 2 to N-1). Likewise, the amount of power consumed by a cstate decreases with index value (e.g., Cₙ consumes less power than Cₙ₋₁). In cstates other than C₀, the CPU 208 is not able to execute instructions. Power consumption is reduced by such actions as turning off power to the CPU 208, turning off and/or slowing down a clock, flushing caches to memory, storing an execution state to memory, or other actions.

In some applications a user may request allocation of CPUs 208 to a pod 112, e.g., a request for a minimum number of CPUs 208 and, for burstable pods, a limit indicating a maximum number available when needed. In conventional Kubernetes, the burstable pod 112 will be assigned a number of CPUs 208 (“CPUset) that includes all available CPUs 208 regardless of the limit or request. These allocated CPUs 208 will then all be placed in cstate corresponding to the state of operation of the burstable pod 112 regardless of whether all of the allocated CPUs 208 are currently needed by the burstable pod. In particular, the CPU manager used by the Kubelet 202 will assign cpushares/cpuquta to a CPUset for the pod 112 according to the request and limit regardless of actual workload. Threads and processes of a container 114 of the pod 112 will therefore be assigned to any of the CPUs 208 in the CPUset, keeping these CPUs 208 in a higher power consumption cstate.

The default KUBERNETES policy of spreading pods across all available cores (for burstable and best effort pods) means any pod can run anywhere leading to no constraints, which means CPU power strategies cannot be enforced effectively. For burstable pods, a CPU manager in conventional KUBERNETES assigns the entire CPUset available on a server 102 and assigns CPUshares/CPUquota equivalent to requests and limits, respectively. Since the workloads get access to the entire CPUset, the pod spawns threads/processes on any CPU core from the assigned CPUset, thereby keeping those CPUs active in C₀ intermittently, hence consuming higher power. Using the approach described herein, the amount of time that CPUs 208 spend in lower consumption cstates is increased.

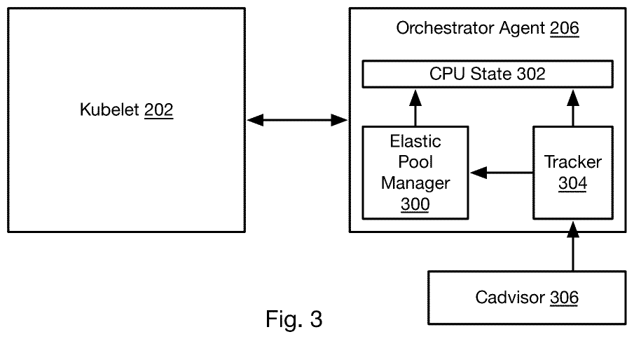

Referring to FIG. 3, the orchestrator agent 206 may include an elastic pool manager 300 that configures a CPU state 302 for each pod. The elastic pool manager 300 further receives input from a tracker 304 that tracks usage by containers of a pod, such as by processing utilization statistics for each container 114 of a pod, such as using “cAdvisor” 306 for DOCKER containers or other source of utilization statistics.

The CPU state 302 for a pod 112 may include, for each container 114 of a pod, such information as:
A CPU set, e.g., a listing of identifiers of CPUs 208 that the container 114 is allowed to use.
A container identifier that uniquely identifies the container globally or at least relative to other containers 114 of the pod 112.
An original request and/or limit for the container 114, e.g., a requested base number of CPUs and a limit on the total number of CPUs available to the container as received from a user, orchestrator, or other source.
A request CPU set, e.g., a listing of identifiers of CPUs 208 that are allocated to the container 114 initially (e.g., upon instantiation).
An expansion CPU set, e.g., a listing of identifiers of CPUs 208 in addition to the request CPU set that are allocated to the container 114 based on utilization.

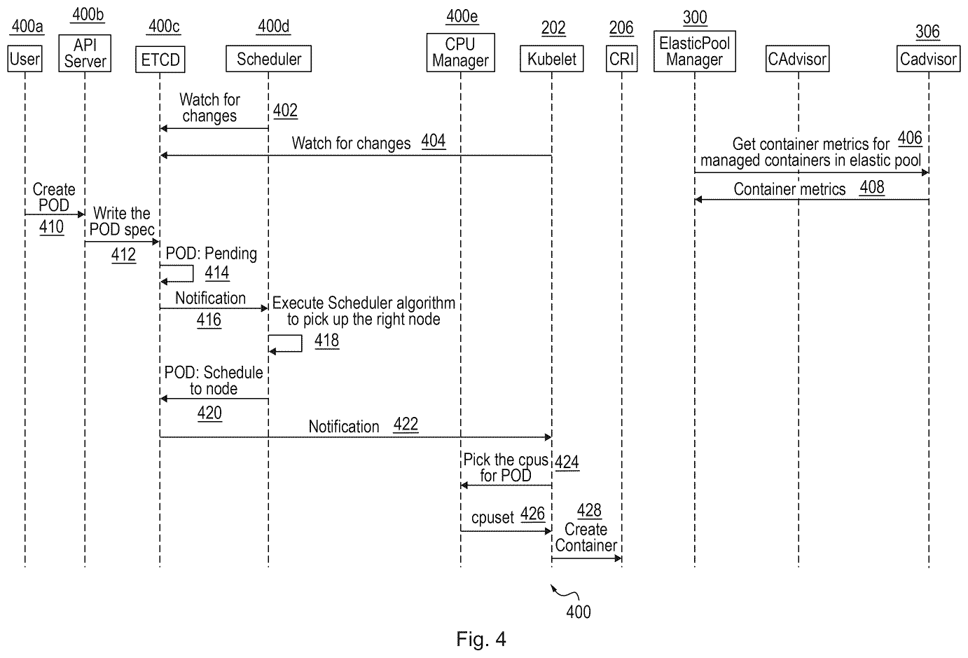

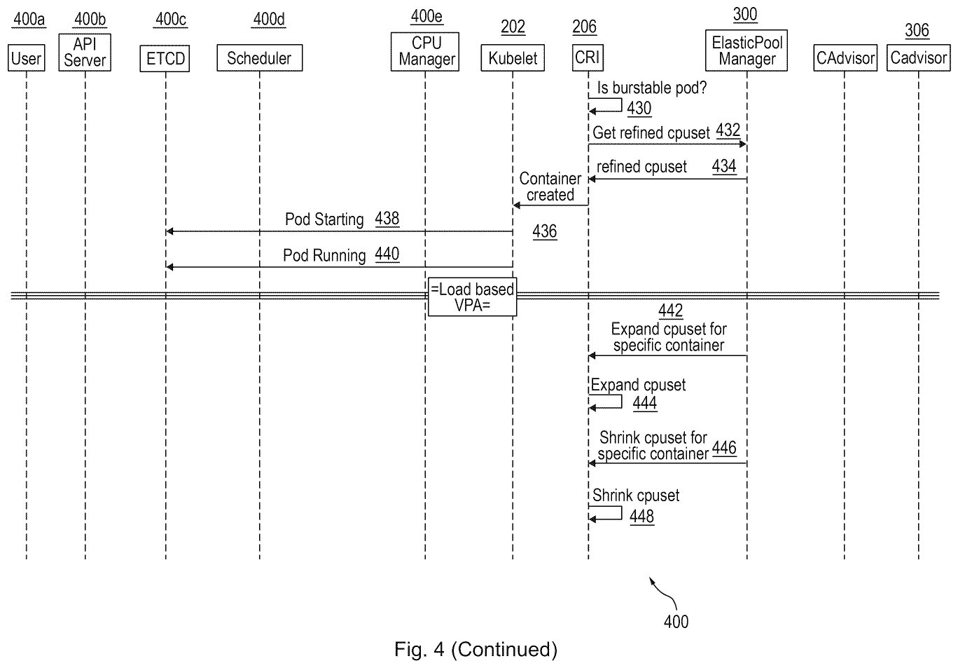

FIG. 4 illustrates a method 400 that may be executed by the elastic pool manager 300 in order to configure the CPU state 302 for each container 114 of a pod 112 based on utilization.

The method 400 may execute on multiple computing devices. For example, the method 400 may be executed with respect to inputs received from a user 400a, such as human user, orchestrator 106, or other entity. A server node may execute an application programming interface (API) server 400b implementing an interface for receiving and executing instructions from the user 400a. The server, or a different server, may execute a key-value store for storing and distributing information describing a state of a KUBERNETES system, such as an ETCD 400c according to the KUBERNETES specification. The server, or a different server, may execute a scheduler 400d for scheduling the performance of tasks, such as tasks performed as part of instantiating pods 112 and containers 114.

The remaining components executing the method 400 may execute on a node executing containers 114 instantiated and managed according to the method 400. For example, the node may execute a CPU manager 400e. The CPU manager 400e may be a component of KUBERNETES or independent of KUBERNETES that manages the placement of workloads, e.g., the selection of CPUs 208 to execute particular containers 114. The node may further execute the Kubelet 202, orchestrator agent 206 (e.g., acting as a CRI 206), the elastic pool manager 300, and the cadvisor 306.

The method 400 may include the scheduler 400d watching 402 for changes received by the ETCD 400c. The Kubelet 202 may likewise watch 404 for changes received by the ETCD 400c. Steps 402, 404 may continue to be performed such that the scheduler 400d and/or Kubelet 202 will detect changes made to the ETCD 400c as described below.

The elastic pool manager 300 may likewise initiate a process of obtaining 406 container metrics for containers 114 managed by the elastic pool manager 300 from the Cadvisor 306, which return 408 container metrics to the elastic pool manager 300. Steps 406, 408 may likewise continue to be performed such that the elastic pool manager 300 periodically receive updates regarding the utilization metrics of containers 114 managed by the elastic pool manager 300.

A user may request 410 creation of a pod 112. The request 410 may include a request to create one or more containers 114 and one or more application instances 118 executing in the containers 114. The request may specify, for each container 114, a CPU requirement. The CPU requirement may include a request and a limit, the request including a first number of CPUs and the limit including a second number of CPUs that is greater than the first number. The request is a minimum number of CPUs 208 required for the container 114 and the limit indicates a maximum number of CPUs 208 that may be used by the container 114, e.g., for bursts. For example, the request may be for one CPU 208 and the limit may be three CPUs 208.

The request 410 may be received by the API server 400b, which may write 412 a pod specification to the ETCD 400c, the pod specification including some or all of the information included in the request as described above. The ETCD 400c may therefore update 414 its state to indicate that a pod 112 is pending creation. As a result, the scheduler 400d, which is watching for changes, will receive 416 a notification of the pod specification and will select 418 a node on which to execute the pod 112.

The scheduler 400d may then transmit 420 an instruction to the ETCD 400c to schedule creation of a pod 112 according to the pod specification in the selected node. In response, the Kubelet 202 executing on the selected node may be notified 422, such as due to the Kubelet 202 watching 404 the ETCD 400c for changes relating to the node executing the Kubelet 202.

The Kubelet 202 may instruct 424 the CPU manager 400e to select CPUs for the pod 112, e.g., corresponding to the request and limit of the pod specification. The CPU manager 400e selects a CPUset from among unallocated CPUs 208 for each container 114 referenced by the pod specification and returns 426 each CPUset, e.g., identifiers of the selected CPUs 208, to the Kubelet 202. Note that either of the request and the limit of the pod specification may be fractional such that a CPU 208 may be allocated to multiple containers 114.

In response to the notification 422, the Kubelet 202 may also instruct 428 the orchestrator agent 206 to create a container 114 for each container referenced in the pod specification. The instruction 428 may include the CPUset for the container 114. The orchestrator agent 206 may evaluate 430 the instruction from step 428 to determine whether the pod 112 including the container 114 is burstable. For example, if the limit is greater than the request for the container 114 in the pod specification, the pod may be deemed burstable. Alternatively, the pod specification may explicitly indicate whether the container 114 is burstable and this information may be passed by the Kubelet 202 to the orchestrator agent 206.

If the pod 112 is not burstable, the orchestrator agent 206 may instantiate the container 114 and bind the CPUs 208 indicated by the CPUset to the container 114. Instantiating the container 114 may include instantiating an application instance 118 to execute within the container 114.

If the pod 112 is found to be burstable, some or all of the remaining steps of the method 400 may be performed. For example, the orchestrator agent 206 may request 432 that the elastic pool manager 300 generate a refined CPUset. The elastic pool manager 300 may generate the refined CPUset by reducing the number of CPUs 208 included in the refined CPUset relative to the CPUset received from the Kubelet 202 (“the original CPUset”). For example, the refined CPUset may be a reduced set having a third number of CPUs that is greater than the first number but less than the third number.

The reduction of the refined CPUset relative to the original CPUset may be determined various ways:
The reduction may be selected according to a fixed function, e.g., a linear, quadratic, exponential, or other mathematical relationship that may be evaluated with respect to the number of CPUs 208 in the original CPUset to obtain the number of CPUs in the refined CPUset.
The reduction may be selected according to a fixed function that is associated with the container 114 to be created, e.g., the application instance 118 to be executed by the container 114. Different application instances 118 may have different usage profiles such that a fixed function may be selected for each type of application instance 118 to account for this fact.
The reduction may be selected as a function of loading of the node on which the container 114 is to be instantiated: the greater the loading, the greater the reduction.

The elastic pool manager 300 calculates the refined CPUset and returns 434 the refined CPUset to the orchestrator agent 206. For example, the elastic pool manager 300 may remove identifiers of CPUs 208 from the original CPUset to obtain the refined CPUset such that the number of CPUs in the refined CPUset is according to the reduction determined by the elastic pool manager 300 as described above.

The orchestrator agent 206 may then instantiate the container 114, bind the container 114 to the CPUs in the refined CPUset, and notify 436 the Kubelet 202 that the container 114 has been created. The Kubelet 202 may start the pod 112 including the container 114 and notify 438 the ETCD 400c when the pod 112 including the container 114 is starting and notify 440 the ETCD 400c when the pod 112 is running.

While the pod 112 and container 114 are running, the elastic pool manager 300 may evaluate utilization by the container 114, such as using utilization metrics provided by the cadvisor 306. If the utilization meets a high threshold condition, the elastic pool manager 300 may instruct 442 the orchestrator agent 206 to expand the CPUset for the container 114, e.g., add identifiers of one or more available CPUs 208 to the CPUset up to the limit included in the pod specification and the orchestrator agent 206 expands 444 the CPUset for the container 114 according to the instruction from step 442. If the utilization meets a low threshold condition, the elastic pool manager 300 may instruct 446 the orchestrator agent 206 to shrink the CPUset for the container 114, e.g., remove from the CPUset. The number of CPUs removed may be limited such that the refined set includes no less than specified in the request included in the pod specification. The orchestrator agent 206 shrinks 448 the CPUset for the container 114 according to the instruction from step 446.

The high threshold condition may include the CPUs 208 of the CPUset being used at X percent capacity, where X is a value greater than 80, greater than 90, or greater than 95. The low threshold condition may include the CPUs 208 of the CPUset being used at Y percent capacity, where Y is a value less than 60, less than 50, or less than 40.

Using the approach described herein, CPUs that are not needed will not be bound to a container and may therefore remain in a low power consumption cstate (e.g., cstates C₁ to Cₙ₋₁). The CPUs 208 are still assigned to pods 112 according to the original CPUset determined by the CPU manager 400e, which is ultimately responsible for tracking the allocation of CPUs 208. However, some of the CPUs 208 will be made unavailable for use by threads and processes of containers 114 of a pod 112 when the workload of the containers 114 do not require use of those CPUs 208.

FIG. 5 illustrates an embodiment of a computing device 500. As shown in FIG. 5, the device 500 processor 510, a memory 520, a storage component 530, an input component 540, an output component 550, a communication interface 560, and a bus 570.

The processor 510, as used herein, means any type of computational circuit that may comprise hardware elements and software elements. The processor 510 may be embodied as a multi-core processor, a single core processor, or a combination of one or more multi-core processors and/or one or more single core processors, a distributed processing system, or the like. The processor 510 may be a Central Processing Unit (CPU) a graphics processing unit (GPU), an accelerated processing unit (APU), an application-specific integrated circuit (ASIC), or another type of processing component.

Memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 cause the processor 510 to perform one or more method steps of an embodiment described above.

Storage component 530 stores information and/or software related to the operation and use of the device 500. For example, storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

Output component 550 is configured to provide output information from the device 500. For example, the output component 550 may be, but not limited to, a display, a speaker, instructions to an external device, and/or one or more light-emitting diodes (LEDs).

Communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the device 500 and other devices. In other words, the standard of the communication interface 560 is not limited.

The bus 570 acts as an interconnect between the processor 510, the memory 520, the storage component 530, the input component 540, the output component 550, and the communication interface 560 of the device 500. The bus 570 may include a wired interconnection or a wireless interconnection.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500. Further, one or more method steps described in any of the embodiments may be performed utilizing a plurality of devices 500 in communication with one another.

In a first example embodiment, a system includes: a plurality of processor cores; and a memory device operably coupled to the plurality of processor cores, the memory device storing executable code that, when executed by the plurality of processor cores, causes the plurality of processor cores to: receive a specification for a software module, the specification including a request for a first number of processor cores of the plurality of processor cores and a limit of a second number of processor cores of the plurality of processor cores that is greater than the first number; reserve a full set of processor cores including the second number of processor cores of the plurality of processor cores for use by an instance of the software module; instantiate the instance of the software module; and configure the instance to use a reduced set of processors cores of the plurality of processors cores, the reduced set of processor cores including a third number of processor cores of the plurality of processor cores, the third number being greater than the first number and less than the second number.

In a second example embodiment of the first example embodiment, the executable code, when executed by the plurality of processor cores, further causes the plurality of processor cores to maintain a portion of the full set of processor cores that are not in the reduced set of processor cores in a lower power consumption state than the reduced set of processor cores.

In a third example embodiment of the first example embodiment, the executable code, when executed by the plurality of processor cores, further causes the plurality of processor cores to: detect first loading of the software module; in response to detecting the first loading, add one or more additional processor cores of the plurality of processor cores to the reduced set of processor cores such that the reduced set of processor cores includes up to the second number of processor cores of the plurality of processor cores; and configure the instance to use the one or more additional processor cores.

In a fourth example embodiment of the third example embodiment, the executable code, when executed by the plurality of processor cores, further causes the plurality of processor cores to: detect second loading of the software module; in response to detecting the second loading, remove the one or more additional processor cores of the plurality of processor cores from the reduced set of processor cores; and configure the instance to no longer use the one or more additional processor cores.

In a fifth example embodiment of the first example embodiment, the executable code, when executed by the plurality of processor cores, further causes the plurality of processor cores to: detect first loading of the software module; in response to detecting the first loading, remove one or more processor cores of the plurality of processor cores from the reduced set of processor cores such that the reduced set of processor cores includes no less than the first number of processor cores of the plurality of processor cores; and configure the instance to no longer use the one or more processor cores.

In a sixth example embodiment of the first example embodiment, at least one of the first number, the second number, and the third number are non-integers.

In a seventh example embodiment of the first example embodiment, the software module includes a pod according to KUBERNETES.

In an eight example embodiment of the first example embodiment, the instance of the software module includes a container.

In a ninth example embodiment of the eight example embodiment, the executable code, when executed by the plurality of processor cores, further causes the plurality of processor cores to: instantiate the container by requesting instantiation by a container runtime interface.

In a tenth example embodiment of the ninth example embodiment, the executable code, when executed by the plurality of processor cores, further causes the plurality of processor cores to: configure, by the container runtime interface, the container to use the reduced set of processor cores of the plurality of processor cores.

In an eleventh example embodiment, a method includes: receiving, by a computing device, a specification for a software module, the specification including a request for a first number of processor cores of a plurality of processor cores of the computing device and a limit of a second number of processor cores of the plurality of processor cores that is greater than the first number; reserving, by the computing device, a full set of processor cores including the second number of processor cores of the plurality of processor cores for use by an instance of the software module; instantiating, by the computing device, the instance of the software module; and configuring, by the computing device, the instance to use a reduced set of processors cores of the plurality of processors cores, the reduced set of processor cores including a third number of processor cores of the plurality of processor cores, the third number being greater than the first number and less than the second number.

In a twelfth example embodiment of the eleventh example embodiment, the method further includes maintaining, by the computing device, a portion of the full set of processor cores that are not in the reduced set of processor cores in a lower power consumption state than the reduced set of processor cores.

In a thirteenth example embodiment of the eleventh example embodiment, the method further includes: detecting, by the computing device, first loading of the software module; in response to detecting the first loading, adding, by the computing device, one or more additional processor cores of the plurality of processor cores to the reduced set of processor cores such that the reduced set of processor cores includes up to the second number of processor cores of the plurality of processor cores; and configuring, by the computing device, the instance to use the one or more additional processor cores.

In a fourteenth example embodiment of the thirteenth example embodiment, the method further includes: detecting, by the computing device, second loading of the software module; in response to detecting the second loading, removing, by the computing device, the one or more additional processor cores of the plurality of processor cores from the reduced set of processor cores; and configuring, by the computer system, the instance to no longer use the one or more additional processor cores.

In a fifteenth example embodiment of the eleventh example embodiment, the method further includes: detecting, by the computing device, first loading of the software module; in response to detecting the first loading, removing, by the computing device, one or more processor cores of the plurality of processor cores from the reduced set of processor cores such that the reduced set of processor cores includes no less than the first number of processor cores of the plurality of processor cores; and configuring, by the computing device, the instance to no longer use the one or more processor cores.

In a sixteenth example embodiment of the eleventh example embodiment, at least one of the first number, the second number, and the third number are non-integers.

In a seventeenth example embodiment of the eleventh example embodiment, the software module includes a pod according to KUBERNETES.

In a eighteenth example embodiment of the eleventh example embodiment, the instance of the software module includes a container.

In a nineteenth example embodiment of the eighteenth example embodiment, the method further includes instantiating, by the computing device, the container by requesting instantiation by a container runtime interface (CRI).

In a twentieth example embodiment of the nineteenth example embodiment, the method further includes configuring, by the container runtime interface, the container to use the reduced set of processor cores of the plurality of processor cores.

1. A system comprising:
a plurality of processor cores; and
a memory device operably coupled to the plurality of processor cores, the memory device storing executable code that, when executed by the plurality of processor cores, causes the plurality of processor cores to:
receive a specification for a software module, the specification including a request for a first number of processor cores of the plurality of processor cores and a limit of a second number of processor cores of the plurality of processor cores that is greater than the first number;
reserve a full set of processor cores including the second number of processor cores of the plurality of processor cores for use by an instance of the software module;
instantiate the instance of the software module; and
configure the instance to use a reduced set of processors cores of the plurality of processors cores, the reduced set of processor cores including a third number of processor cores of the plurality of processor cores, the third number being greater than the first number and less than the second number.

2. The system of claim 1, wherein the executable code, when executed by the plurality of processor cores, further causes the plurality of processor cores to maintain a portion of the full set of processor cores that are not in the reduced set of processor cores in a lower power consumption state than the reduced set of processor cores.

3. The system of claim 1, wherein the executable code, when executed by the plurality of processor cores, further causes the plurality of processor cores to:
detect first loading of the software module;
in response to detecting the first loading, add one or more additional processor cores of the plurality of processor cores to the reduced set of processor cores such that the reduced set of processor cores includes up to the second number of processor cores of the plurality of processor cores; and
configure the instance to use the one or more additional processor cores.

4. The system of claim 3, wherein the executable code, when executed by the plurality of processor cores, further causes the plurality of processor cores to:
detect second loading of the software module;
in response to detecting the second loading, remove the one or more additional processor cores of the plurality of processor cores from the reduced set of processor cores; and
configure the instance to no longer use the one or more additional processor cores.

5. The system of claim 1, wherein the executable code, when executed by the plurality of processor cores, further causes the plurality of processor cores to:
detect first loading of the software module;
in response to detecting the first loading, remove one or more processor cores of the plurality of processor cores from the reduced set of processor cores such that the reduced set of processor cores includes no less than the first number of processor cores of the plurality of processor cores; and
configure the instance to no longer use the one or more processor cores.

6. The system of claim 1, wherein at least one of the first number, the second number, and the third number are non-integers.

7. The system of claim 1, wherein the software module includes a pod according to KUBERNETES.

8. The system of claim 1, wherein the instance of the software module includes a container.

9. The system of claim 8, wherein the executable code, when executed by the plurality of processor cores, further causes the plurality of processor cores to:
instantiate the container by requesting instantiation by a container runtime interface.

10. The system of claim 9, wherein the executable code, when executed by the plurality of processor cores, further causes the plurality of processor cores to:
configure, by the container runtime interface, the container to use the reduced set of processor cores of the plurality of processor cores.

11. A method comprising:
receiving, by a computing device, a specification for a software module, the specification including a request for a first number of processor cores of a plurality of processor cores of the computing device and a limit of a second number of processor cores of the plurality of processor cores that is greater than the first number;
reserving, by the computing device, a full set of processor cores including the second number of processor cores of the plurality of processor cores for use by an instance of the software module;
instantiating, by the computing device, the instance of the software module; and
configuring, by the computing device, the instance to use a reduced set of processors cores of the plurality of processors cores, the reduced set of processor cores including a third number of processor cores of the plurality of processor cores, the third number being greater than the first number and less than the second number.

12. The method of claim 11, further comprising maintaining, by the computing device, a portion of the full set of processor cores that are not in the reduced set of processor cores in a lower power consumption state than the reduced set of processor cores.

13. The method of claim 11, further comprising:
detecting, by the computing device, first loading of the software module;
in response to detecting the first loading, adding, by the computing device, one or more additional processor cores of the plurality of processor cores to the reduced set of processor cores such that the reduced set of processor cores includes up to the second number of processor cores of the plurality of processor cores; and
configuring, by the computing device, the instance to use the one or more additional processor cores.

14. The method of claim 13, further comprising:
detecting, by the computing device, second loading of the software module;
in response to detecting the second loading, removing, by the computing device, the one or more additional processor cores of the plurality of processor cores from the reduced set of processor cores; and
configuring, by the computer system, the instance to no longer use the one or more additional processor cores.

15. The method of claim 11, further comprising:
detecting, by the computing device, first loading of the software module;
in response to detecting the first loading, removing, by the computing device, one or more processor cores of the plurality of processor cores from the reduced set of processor cores such that the reduced set of processor cores includes no less than the first number of processor cores of the plurality of processor cores; and
configuring, by the computing device, the instance to no longer use the one or more processor cores.

16. The method of claim 11, wherein at least one of the first number, the second number, and the third number are non-integers.

17. The method of claim 11, wherein the software module includes a pod according to KUBERNETES.

18. The method of claim 11, wherein the instance of the software module includes a container.

19. The method of claim 18, further comprising:
instantiating, by the computing device, the container by requesting instantiation by a container runtime interface (CRI).

20. The method of claim 19, further comprising:
configuring, by the container runtime interface, the container to use the reduced set of processor cores of the plurality of processor cores.
